(19) United States
(12) Patent Application Publication
(10) Pub. No.: US 2009/0119975 A1
(43) Pub. Date: May 14, 2009

(54) Tackle box

(76) Inventor: Christine Yearack, Sun City, AZ (US)

Correspondence Address: GALLAGHER & KENNEDY, P. A., 2575 E. CAMELBACK RD. #1100, PHOENIX, AZ, 85016, US

(21) Appl. No.: 11/974,403

(22) Filed: Oct. 11, 2007

(51) Int. Cl. A01K 97/06; A47C 7/62

(52) U.S. Cl. 43/54.1; 297/188.2

(57) ABSTRACT

There is provided a soft tackle box for use with a boat seat having a top surface, a front surface, a bottom surface, a rear surface, a left side surface, and a right side surface, and the boat seat attached to a pedestal that is secured to a boat deck, and wherein the boat seat further defines a side seat position proximate to both the left side surface, and the right side surface. The soft tackle box may comprise: a flexible wall section defining an exposed surface and a seat surface, and further defining a first side edge, a second side edge, a front edge, and a rear edge, and the wall section further defining a first storage section and a second storage section; a support section affixed to the wall section wherein the support section defines an extended front edge; at least one strap affixed to the extended front edge and the rear edge; wherein the wall section is configured so that when the seat surface covers the boat seat top surface, the storage sections hang at the side seat position; and wherein the strap is configured so as to pass over the front surface, the bottom surface, and the rear surface of the boat seat, so as to secure the tackle box to the boat seat.

### FIELD OF THE INVENTION

The present invention relates to sporting goods. More particularly the present invention relates to an improve tackle box that may be easily secured on a boat seat for convenience.

### BACKGROUND OF THE INVENTION

Recreational activities and outdoor activities are popular pass times in contemporary life. Golfing, boating, camping, and other sports-related activities are examples of popular recreational activities. Fishing, just to take one example, is estimated as a multibillion dollar industry in America.

In pursuing fishing activities, individuals often have a need to carry lures and fishing-related items on a boat. Tackle boxes have been developed to accomplish this. In a well known example a tackle box is a hard-sided box that opens up to show contents stored in the inside. The interior of the box contains trays for individual items such as lures, hooks, bobbers, weights, etc. However, in using such a tackle box in many boat layouts the tackle box suffers from a distinct disadvantage. The tackle box must often be positioned in some area away from the boat seat. During travel, the bumping and movement of the boat will frequently make a tackle box move or bounce around, even bouncing out of the boat, unless it is secured. Thus, it would be desired to provide a tackle box that can travel securely and without risk of movement during boating travel.

A further disadvantage related to common tackle boxes is the placement of the tackle box relative to the fisherman. When fishing from a boat, a fisherman commonly takes a seat, also referred to herein as a boat seat. While resting in the boat seat the fisherman uses the fishing pole to undertake common fishing activities such as rigging the rod, applying bait and lures, casting, retrieving, and landing fish. It is undesirable for the fisherman to get up from the boat seat multiple times. Repeatedly getting up from the boat seat is cumbersome and tiring; further, in heavy seas it can be dangerous to stand in the boat. Thus, it would be desired to provide a tackle box that can be securely positioned in proximity to a boat seat, so that a fisherman can access the contents of the tackle box without need to arise or move from the boat seat.

Hence there has been identified a need to provide an improved tackle box that can be securely positioned during boat travel. Further, there is a need that the improved tackle box be adapted so that it can be positioned in close proximity to a boat seat, allowing a fisherman to access the tackle box contents while remaining seated in the boat seat. It is further desired that an improved tackle box be provided that is robust, relatively inexpensive, carries a multitude of fishing items, and that can be retrofit to existing boat seat designs. The present invention addresses one or more of these needs.

### SUMMARY OF THE INVENTION

In accordance with one aspect of the present invention, and by way of example only, a flexible tackle box is provided that can be attached to a boat seat having a top surface, a front surface, a bottom surface, a rear surface, a left side surface, and a right side surface, and wherein the boat seat further defines a side seat position proximate to both the left side surface, and the right side surface. The tackle box includes a flexible wall section defining an exposed surface and a seat surface, and further defining a first side edge, a second side edge, a front edge, and a rear edge, and the wall section further defining a first storage section and a second storage section; a support section affixed to the wall section wherein the support section defines an extended front edge; at least one strap, which may be of a resilient material, affixed to the extended front edge and the rear edge; wherein the wall section is configured so that when the seat surface covers the boat seat top surface, the storage sections hang at the side seat position; and wherein the strap is configured so as to pass over the front surface, the bottom surface, and the rear surface of the boat seat, so as to secure the tackle box to the boat seat. The tackle box may further include a pair of straps, which each may be of a resilient material. The tackle box may further include at least one pocket disposed on the exposed surface of the first storage section, and at least one pocket disposed on the exposed surface of the second storage section. Optionally, the tackle box may further include a pair of pockets disposed on the exposed surface of the first storage section, and a pair or pockets disposed on the exposed surface of the second storage section. Each pocket may include an opening and wherein each pocket is positioned so that each opening faces upward relative to the boat seat orientation. The tackle box may have a lure holder disposed in each pocket. The tackle box may have the flexible wall section comprised of a material such as cotton or canvas or nylon. The straps may also include a snap buckle affixed to the strap such that opposing ends of the strap can be joined at the buckle. Additionally the slide buckle may be configured so that the straps can be tightened by movement through the buckle.

In another aspect of the present invention, still by way of example only, there is provided a soft tackle box for use with a boat seat having a top surface, a front surface, a bottom surface, a rear surface, a left side surface, and a right side surface, and the boat seat attached to a pedestal that is secured to a boat deck, and wherein the boat seat further defines a side seat position proximate to both the left side surface, and the right side surface. The soft tackle box may comprise: a flexible wall section defining an exposed surface and a seat surface, and further defining a first side edge, a second side edge, a front edge, and a rear edge, and the wall section further defining a first storage section and a second storage section; a support section affixed to the wall section wherein the support section defines an extended front edge; at least one strap affixed to the extended front edge and the rear edge; wherein the wall section is configured so that when the seat surface covers the boat seat top surface, the storage sections hang at the side seat position; and wherein the strap is configured so as to pass over the front surface, the bottom surface, and the rear surface of the boat seat, so as to secure the tackle box to the boat seat. The tackle box may have at least one pocket disposed on the exposed surface of the first storage section, and at least one pocket disposed on the exposed surface of the second storage section. Optionally, the tackle box may have a pair of pockets disposed on the exposed surface of the first storage section, and a pair or pockets disposed on the exposed surface of the second storage section. Each pocket may include an opening and wherein each pocket is positioned so that each opening faces upward relative to the boat seat orientation. A lure holder for holding fishing items may be disposed in the pockets. The flexible wall section of the tackle box may be comprised of a material such as cotton or canvas or nylon. Optionally, the soft tackle box may have a pair of flexible straps of a resilient material.

In still a further aspect of the present invention, and still by way of example only there is provided a method for positioning a flexible tackle box on a fishing boat seat, wherein the boat seat includes a top surface, a front surface, a bottom surface, and a rear surface, the method comprising the steps of: placing a seat surface of a wall section of a flexible tackle box so as to contact the top surface of the seat; drawing a first strap underneath the seat; clipping a snap buckle affixed to the strap; and cinching the strap so as to draw the tackle box securely against the seat. The method may further include the steps of drawing a second strap underneath the seat; clipping a second snap buckle affixed to the second strap; and cinching the second strap so as to draw the tackle box securely against the seat. Additionally, the method may also include the step of positioning a tackle holding box in a pocket positioned on the flexible tackle box.

Other independent features and advantages of the improved tackle box will become apparent from the following detailed description, taken in conjunction with the accompanying drawings which illustrate, by way of example, the principles of the invention.

### BRIEF DESCRIPTION OF THE DRAWINGS

FIG. 1 is a top view of a tackle box, according to an embodiment of the present invention;

FIG. 2 is a bottom view of a tackle box, according to an embodiment of the present invention;

and

FIG. 3 is a perspective view of a tackle box disposed on a boat seat, according to an embodiment of the present invention.

### LIST OF REFERENCE NUMERALS

Wherever possible, the same reference numbers will be used throughout the drawings to refer to the same or like parts.
10 tackle box
11 top surface
12 bottom surface
13 front surface
14 rear surface
15 left side surface
16 right side surface
17 boat seat
18 boat seat pedestal
19 boat deck
20 flexible wall section
21 exposed surface
22 seat surface
23 first side edge
24 second side edge
25 front edge
26 rear edge
27 first storage section
28 second storage section
29 support section
30 strap
31 slip-adjustable buckle
32 pocket
33 opening
34 opening cover
35 lure holder
36 seat pad
37 left side fold
38 right side fold
39 clasp

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention. Reference will now be made in detail to exemplary embodiments of the invention, examples of which are illustrated in the accompanying drawings.

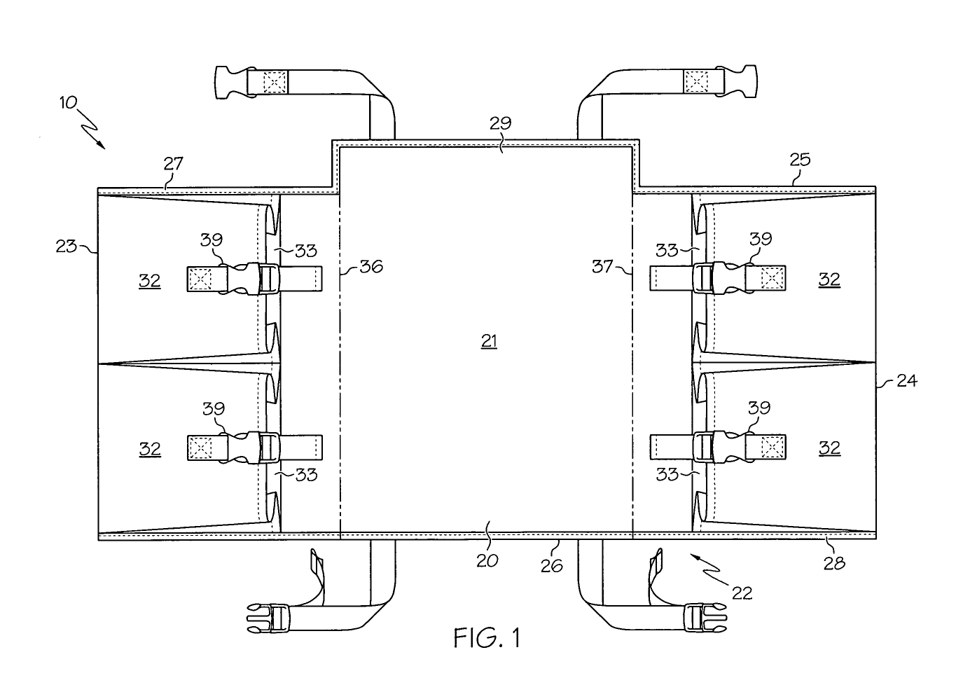

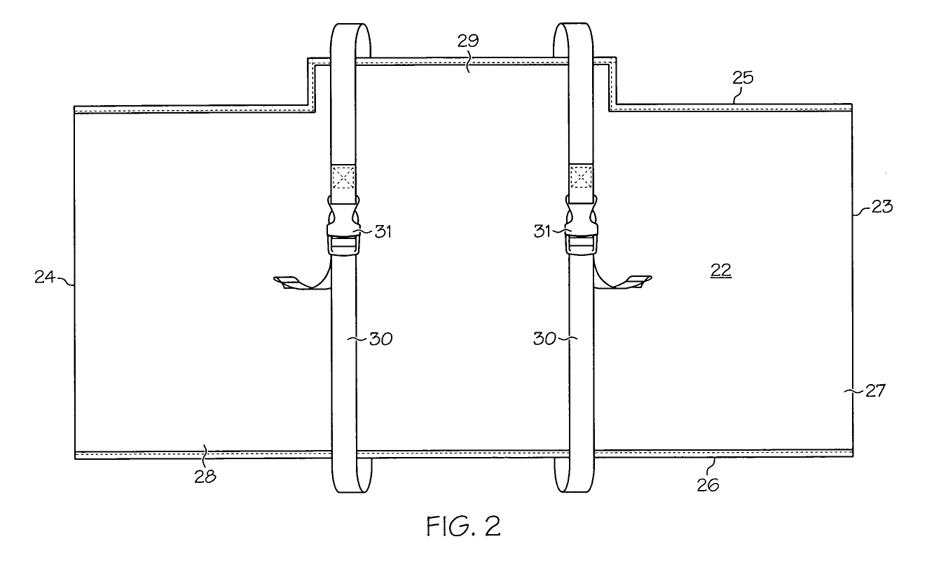

Referring now to FIGS. 1 and 2 there is shown a top perspective view and a bottom perspective view respectively of an improved tackle box 10. Tackle box 10 includes a flexible wall section 20. Flexible wall section 20 defines an exposed surface 21, seat surface 22, first side edge 23, and second side edge 24. Additionally flexible wall section has a front edge 25 and a rear edge 26. In a preferred embodiment, improved tackle box 10, when lying flat, is generally rectangular in shape, although different shapes are possible. It is found that a generally rectangular shape is well suited to the intended purpose of tackle box 10; i.e., the rectangular shape allows tackle box 10 to rest on a boat seat surface so that side sections of the tackle box in turn hang to the right and to the left of the boat seat, in good position for access by an individual sitting on the boat seat.

Referring again to FIGS. 1 and 2, the tackle box 10 additionally may include a support section 29. Generally described, support section 29 is an extension of the front edge 25. Support section can be folded down over the front of a boat seat so as to allow the tackle box 10 to be well secured to the boat seat as further described herein.

Additionally, tackle box 10 includes a first storage section 27 and second storage section 28. Storage sections 27 and 28 can be unitary pieces with flexible wall section 20. For example, flexible wall section 20 can be formed of a single piece of fabric or material. Cotton or canvas are typically preferred materials. In such a case, first storage section 27 and second storage section 28 are segments of the flexible wall section 20.

Pockets 32 can be disposed on each of the first storage section 27 and second storage section 28. In a preferred embodiment, a pocket 32 is formed by sewing an additional piece of fabric or material to flexible wall section 20. The additional piece of material and the flexible wall section 20 thus form a pocket 32. Preferably the pocket 32 is dimensioned to receive and hold an item such as a lure holder 35 or hard case. Pockets 32 may include an opening 33, through which lure holder 35 is placed. In a preferred embodiment pockets 32 are closed by a strap and clasp 39 which also secures lure holder 35 within pocket 32. There may in some embodiments be included an opening cover 34 which can close opening 33 so as to secure lure holder 35 within pocket 32. In a preferred embodiment a pair of pockets 32 are positioned on each of first storage section 27 and second storage section 28, though a different number is possible.

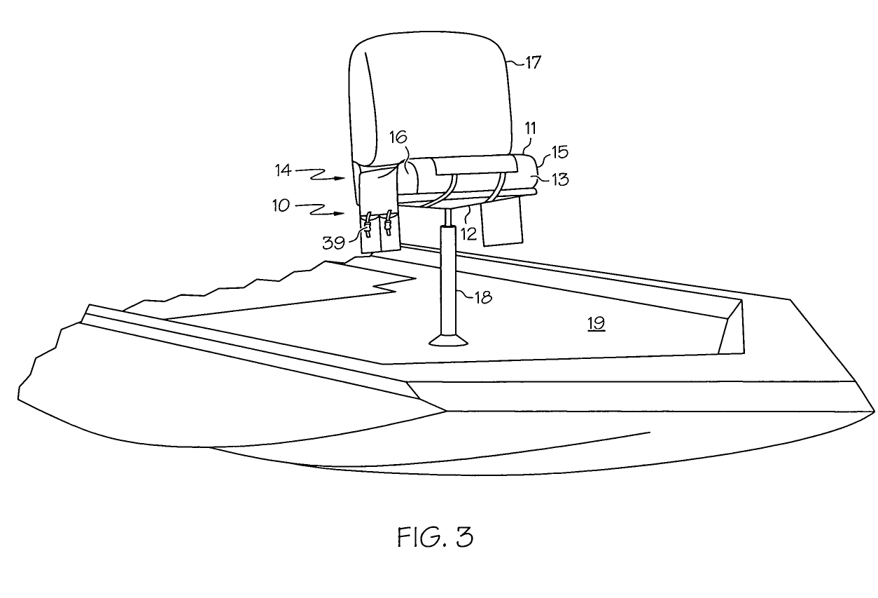

It is to be additionally noted that pockets 32 are positioned in a preferred manner. As shown in FIG. 3, pockets 32 are positioned so that opening 33 faces upward, relative to the orientation of the boat seat 17 when tackle box 10 is positioned on boat seat 17. In this manner, a user/individual who is sitting on the boat seat 17 can reach down, relative to the orientation of the individual and reach directly into each of the pockets 32. Further, the pockets 32 are preferably positioned sufficiently high, again relative to the user/individual so that by a simple arm's reach, the individual can access the contents of the pockets 32.

As best shown in FIG. 2, tackle box 10 preferably includes a strap 30, and preferably a pair of straps 30, secured to tackle box 10. Preferably a pair of straps 30, which may be of a resilient or elastic material, are connected to tackle box 10 so that the straps 30 extend from the front edge 25 (or near the front edge 25) to the rear edge 26 (or near the rear edge 26.) In those embodiments of the tackle box that include a support section 29, the straps 30 can be connected to the support section 29. In further embodiments, the straps may include a slip-adjustable buckle 31 (sometimes referred to as “buckle”). When the embodiment includes buckle 31, straps 30 may be divided into a first section and second section. As is known in the art, a first strap section is connected to a first portion of buckle 31 and the second strap section is connected to the second portion of buckle 31. The first and second portions of buckle 31 are reciprocally configured so that they are connected to form a completed buckle. Further, the buckle is a slip adjustable buckle 31 in that straps 30 can be tightened or loosened by “cinching” or moving the strap relative to buckle 31.

As previously mentioned tackle box 10 is designed so as to be easily attached to or disposed on a boat seat 17 as shown in FIG. 3. The typical boat seat configuration as shown in FIG. 3 includes a boat deck 19, boat seat pedestal 18 (which may be referred to as just “pedestal”), and boat seat 17. Further, boat seat 17 includes a top surface 11, bottom surface 12, front surface 13, rear surface 14, left side surface 15, and right side surface 16. It will here be appreciated that the definition of surfaces 11 through 16 may in some boat seat configurations be approximate; for example, some boat seat configurations may have rounded corners rather than sharp definitions between surfaces. However, for information purposes regarding the positioning and usage of tackle box 10, these conventions are useful. In operation, tackle box 10 is positioned relative to boat seat 17 so that the seat surface 22 of flexible wall section is placed upon the top surface 11 of boat seat 17. In such a position the exposed surface 21 of tackle box 10 thus faces “up” relative to the orientation of boat seat 17. Further, tackle box 10 is generally dimensioned so that upon being placed on boat seat 17, the first storage section 27 hangs down in proximity to a left side surface 15 of the boat seat 17, and the second storage section 28 hangs down in proximity to a right side surface 16 of boat seat 17. In the illustrated placement, the front edge 25 of flexible wall section 20 is placed in proximity to the front surface 13 of boat seat 17, and likewise, the rear edge 26 of flexible wall section 20 is placed in proximity to the rear surface 14 of boat seat 17.

Flexible wall section 20 can, in some embodiments, include a left side fold 37 and right side fold 38. Left side fold 37 serves to divide seat surface 22 and exposed surface 21 from first storage section 27, also divides seat surface 22 and exposed surface 21 from second storage section 28.

In placing tackle box 10 on boat seat 17 strap 30 has been moved so as to hold and secure tackle box 10 to the boat seat 17 in the following manner. If strap is a single continuous piece, a strap 30 slides into contact with bottom surface 12 of boat seat 17 by, for example, sliding over the left side surface 15 or the right side surface 16 of the boat seat 17. When a pair of straps 30, as is preferred, is present, each of the straps 30 may be positioned so as to come to rest on opposite sides of pedestal 18. In the embodiment with unitary straps 30, it is preferred that the straps 30 be at least partially formed of a resilient or elastic material so that in placing the straps 30 around the seat 17 there is induced some tension within the straps 30 which tension tends to hold them in place. If the tackle box embodiment includes straps 30 with buckle 31 the straps 30 can be tensioned or detensioned by sliding the strap 30 relative to the buckle 31.

It is generally preferred that straps 30 be tightened so as to sufficiently hold tackle box 10 in place on boat seat 17. Thus movement of a boat will not allow tackle box 10 to be disturbed from its position during normal boat operations. In this manner a user/individual can position the tackle box 10 on a boat seat 17 at the beginning of the day, tighten the tackle box 10 in place, and then forget about it. The user will not have to worry about securing or repositioning the tackle box 10 when the boat moves from the dock to the fishing location or between fishing locations. Additionally, the advantageous placement of the tackle box 10 in close proximity to boat seat 17 allows a user to readily access the contents of the tackle box 10. There is no need for the user to make wearying trips from his seat to the tackle box location and back to the seat multiple times during a day's fishing. Now the user can have a more relaxing and less stressful outing because the tackle box is in close proximity to the boat seat 17.

It is also noted that a particular embodiment of tackle box 10 minimizes potential wind interference during movement of the boat. As has previously been described one configuration of tackle box 10 includes an extension piece identified as a support section 29. In placing tackle box 10, support section 29 can be configured to wrap down and cover or partially cover the front surface 13 of boat seat 17. Preferably still, support section 29 wraps down around front surface 13 so that the front edge 25 of tackle box 10 now is secured at a position proximate to the bottom surface 12 of boat seat 17. The front edge 25 thus in effect faces to the rear of the boat seat 17. Thus, in a configuration where the boat seat 17 is oriented so as to face the front of the boat wind resistance is minimized. Wind will flow over and above tackle box 10; however flexible wall section 20 now completely covers front surface 13 of boat seat 17. In this kind of position wind cannot easily pass between tackle box 10 and boat seat 17.

It is generally preferred that flexible wall section 20 and other components of tackle box 10 be chosen from weather resistant materials. Nylon and other synthetic materials are thus preferred. Canvas can be an acceptable choice and has advantages in terms of durability and washability. Any flexible material can be used to form flexible wall section 20. It is also noted that flexible wall section 20 can attractively be formed of a material that is well received in the sporting goods market. Thus, for example a camouflage type design can be used. Alternatively, the flexible wall section 20 can receiving printing such as designs or logos or advertisements for sporting related products and manufacturers.

Tackle box 10 can also include a seat pad 36 in some embodiments. Seat pad 36 can be advantageously positioned on exposed surface 21 of flexible wall section 20. In this manner, when tackle box 10 is disposed on boat seat 17, seat pad 36 now generally forms the area upon which the user/individual's buttocks will rest when seated on boat seat 17. Seat pad 36 can be integral with tackle box 10. Alternatively, tackle box 10 can include an additional receiving area into which a seat pad 36 can be positioned.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to a particular embodiment disclosed as the best mode contemplated for carrying out this invention, but that the invention will include all embodiments falling within the scope of the appended claims.

What is claimed is:

1. A flexible tackle box for attachment to a boat seat having a top surface, a front surface, a bottom surface, a rear surface, a left side surface, and a right side surface, and wherein the boat seat further defines a side seat position proximate to both the left side surface, and the right side surface, the tackle box comprising:
a flexible wall section defining an exposed surface and a seat surface, and further defining a first side edge, a second side edge, a front edge, and a rear edge, and the wall section further defining a first storage section and a second storage section;
a support section affixed to the wall section wherein the support section defines an extended front edge;
at least one strap affixed to the extended front edge and the rear edge;
wherein the wall section is configured so that when the seat surface covers the boat seat top surface, the storage sections hang at the side seat position;
and
wherein the strap is configured so as to pass over the front surface, the bottom surface, and the rear surface of the boat seat, so as to secure the tackle box to the boat seat.

2. The tackle box according to claim 1 further comprising a pair of straps.

3. The tackle box according to claim 1 further comprising at least one pocket disposed on the exposed surface of the first storage section, and at least one pocket disposed on the exposed surface of the second storage section.

4. The tackle box according to claim 1 further comprising a pair of pockets disposed on the exposed surface of the first storage section, and a pair or pockets disposed on the exposed surface of the second storage section.

5. The tackle box according to claim 4 wherein each pocket comprises an opening and wherein each pocket is positioned so that each opening faces upward relative to the boat seat orientation.

6. The tackle box according to claim 5 further comprising a lure holder disposed in the pocket.

7. The tackle box according to claim 1 wherein the flexible wall section comprises a material selected from the group consisting of cotton, canvas and nylon.

8. The tackle box according to claim 1 wherein the strap comprises a resilient material.

9. The tackle box according to claim 1 further comprising a snap buckle affixed to the strap.

10. A soft tackle box for use with a boat seat having a top surface, a front surface, a bottom surface, a rear surface, a left side surface, and a right side surface, and the boat seat attached to a pedestal that is secured to a boat deck, and wherein the boat seat further defines a side seat position proximate to both the left side surface, and the right side surface, the soft tackle box comprising:
a flexible wall section defining an exposed surface and a seat surface, and further defining a first side edge, a second side edge, a front edge, and a rear edge, and the wall section further defining a first storage section and a second storage section;
a support section affixed to the wall section wherein the support section defines an extended front edge;
at least one strap affixed to the extended front edge and the rear edge;
wherein the wall section is configured so that when the seat surface covers the boat seat top surface, the storage sections hang at the side seat position;
and
wherein the strap is configured so as to pass over the front surface, the bottom surface, and the rear surface of the boat seat, so as to secure the tackle box to the boat seat

11. The tackle box according to claim 10 further comprising at least one pocket disposed on the exposed surface of the first storage section, and at least one pocket disposed on the exposed surface of the second storage section.

12. The tackle box according to claim 10 further comprising a pair of pockets disposed on the exposed surface of the first storage section, and a pair or pockets disposed on the exposed surface of the second storage section.

13. The tackle box according to claim 11 wherein each pocket comprises an opening and wherein each pocket is positioned so that each opening faces upward relative to the boat seat orientation.

14. The tackle box according to claim 13 further comprising a lure holder disposed in the pockets.

15. The tackle box according to claim 10 wherein the flexible wall section comprises a material selected from the group consisting of cotton and nylon.

16. The soft tackle box according to claim 10 comprising a pair of flexible straps.

17. The soft tackle box according to claim 10 wherein the straps comprise a resilient material.

18. A method for positioning a flexible tackle box on a fishing boat seat, wherein the boat seat includes a top surface, a front surface, a bottom surface, and a rear surface, the method comprising the steps of:
placing a seat surface of a wall section of a flexible tackle box so as to contact the top surface of the sea;
drawing a first strap underneath the seat;
clipping a snap buckle affixed to the strap;
cinching the strap so as to draw the tackle box securely against the seat.

19. The method according to claim 18 further comprising the steps of drawing a second strap underneath the seat; clipping a second snap buckle affixed to the second strap; and cinching the second strap so as to draw the tackle box securely against the seat.

20. The method according to claim 18 further comprising the step of positioning a tackle holding box in a pocket positioned on the flexible tackle box.
